(19) United States
(12) Patent Application Publication
(10) Pub. No.: US 2025/0014129 A1
(43) Pub. Date: Jan. 9, 2025

(54) VEHICLE-BASED SYSTEM FOR ASSISTING INDIVIDUALS IN THEIR INTERACTIONS WITH LAW ENFORCEMENT

(71) Applicant: Legal Equalizer, Inc., Atlanta, GA (US)

(72) Inventor: Mbye Baboucarr Njie, Atlanta, GA (US)

(21) Appl. No.: 18/348,782

(22) Filed: Jul. 7, 2023

(51) Int. Cl. G06Q 50/18; G06V 10/82; G06V 20/58; G06V 20/59; G06V 40/20; G10L 15/16; H04L 12/18; H04L 65/1069; H04L 65/1089

(52) U.S. Cl. CPC G06Q 50/182; G06V 10/82; G06V 20/584; G06V 20/597; G06V 40/20; G10L 15/16; H04L 12/1831; H04L 65/1069; H04L 65/1089

(57) ABSTRACT

The present disclosure relates to systems and methods for reducing potential racial injustice during interactions with law enforcement. A mitigation system can monitor vehicle operating parameters, including location data, to identify indications of a law enforcement encounter. When detected, audio and image capturing devices can be activated to collect relevant data. By utilizing location data, the mitigation system can provide legal information pertaining to the specific law enforcement interaction. This information can be displayed and updated throughout the encounter, based on the audio and/or image data recorded during the law enforcement interaction.

### FIELD

The present disclosure generally relates to the field of vehicle operation and law enforcement and, more particularly, to vehicle-integrated systems for improving situational awareness and bolstering safety during law enforcement interactions.

### BACKGROUND

Traffic stops and law enforcement interactions frequently pose stressful and potentially dangerous situations for both drivers and officers, especially for individuals belonging to marginalized communities such as communities of color, as well as new or inexperienced drivers. These interactions have occasionally led to instances of racial injustice, discrimination, or even tragic outcomes, with these drivers often being particularly vulnerable to potential exploitation or mistreatment during traffic stops. Factors that may compound these interactions include limited understanding of applicable laws and regulations or communication barriers resulting from language differences. The increased risk of racial injustice, bias, or discrimination during police interactions has fueled significant concern, leading to calls for improved transparency and accountability in these interactions.

The adoption of recording devices, including cameras and audio recorders, has increased as a means to enhance transparency and preserve evidence during law enforcement interactions. Many contemporary vehicles feature cameras and other sensors designed to assist with navigation, safety, and various other functions. However, the integration of these vehicle systems into law enforcement interaction scenarios remains underdeveloped.

Furthermore, a substantial number of drivers may be unaware of their rights and the specific laws applicable to police interactions within a given jurisdiction. Acquiring a more comprehensive understanding of local laws and regulations can be important for individuals to protect and exercise their rights effectively during interactions with law enforcement officers.

In addition to the challenges inherent in law enforcement interactions, drivers might encounter enforcement actions due to a lack of familiarity with local traffic patterns or the presence of law enforcement officials in particular areas. This information deficit could prompt drivers to unintentionally engage in risky driving behaviors, potentially leading to traffic stops or other enforcement actions.

### SUMMARY

Embodiments of the present disclosure provide systems and methods for mitigating potential racial injustice during law enforcement interactions. An example method can include monitoring operating parameters of vehicle of a user. The operating parameters can include geographic data for the vehicle. The method can include detecting a presence of a condition indicative of a law enforcement interaction and activating a set of media capturing devices. The set of media capturing devices can include an audio capturing device for obtaining audio data relating to the law enforcement interaction and an image capturing device for obtaining image data relating to the law enforcement interaction. The method can include obtaining first legal information for the law enforcement interaction based on the geographic data; identifying and initiating communication with a legal aid professional based on the geographic data; causing a display within the vehicle to display the first legal information, a communication channel with the legal aid professional; processing the audio data captured by the audio capturing device during the law enforcement interaction to determine a basis for the law enforcement interaction; obtaining second legal information for the law enforcement interaction based on the basis for the law enforcement interaction; and/or causing the display to display the second legal information.

The method of the preceding paragraph can include one or more of the following steps of features of this paragraph. The processing can include inputting the audio data into a trained neural network model that interprets spoken language in the audio data and determines the basis of the law enforcement interaction. The media can include video data captured by the audio capturing device during the law enforcement interaction. The processing can include inputting the video data into a trained neural network model that analyzes and interprets movements and behavior of an officer to determine the basis of the law enforcement interaction. The processing can be executed in a continuous and iterative manner throughout the duration of the law enforcement interaction. The condition indicative of the law enforcement interaction can include a presence of active emergency lights on an emergency vehicle in proximity to the vehicle.

The method of any of the preceding paragraphs can include one or more of the following steps of features of this paragraph. The method can include initiating communication with a predetermined group of contacts; and/or causing a display within the vehicle to display a communication channel with the predetermined group of contacts. The operating parameters can include vehicle status parameters, which can include at least one of speed, direction, geospatial location, exterior lighting status, turn signal usage, windshield wiper operation, seatbelt usage, door lock status, or vehicle weight. The operating parameters can include vehicle performance metrics, which can include at least one of revolutions per minute (RPM), engine temperature, fuel efficiency, tire pressure, or brake status. The operating parameters can include environmental conditions, which can include at least one of ambient light conditions, road conditions, weather data, or traffic patterns. The operating parameters can include safety feature data, which can include at least one of lane-keeping data, adaptive cruise control status, alerts from collision avoidance systems, or airbag deployment status. Activating a set of media capturing devices can be based on a determination that the vehicle is in a parked state. The method can include transmitting the audio data and the video data to a remote storage location for secure and tamper-resistant storage. The legal aid professional can include an attorney, paralegal, or a legal advisor with expertise in local law. The method can include providing the user with suggested responses or actions.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIG. 1 illustrates an embodiment of a mitigation system for mitigating potential racial or other injustice during law enforcement interactions.

FIG. 2 illustrates a diagram of a vehicle equipped with integrated cameras and/or audio capture devices.

FIG. 3 is a schematic representation of a mitigation system 310, integrated into an infotainment center of vehicle and engaged during a law enforcement interaction.

FIG. 4 illustrates an example graphical user interface (GUI) of a vehicle-based system for mitigating potential racial injustice during law enforcement interactions.

FIG. 5A is a diagram illustrating an example of training an advanced language model, in accordance with the present disclosure.

FIG. 5B is a diagram illustrating an example of applying a trained advanced language model to a new observation associated with identifying a jurisdiction-specific legal information.

FIG. 6 is a flow diagram illustrating an embodiment of a routine implemented by a mitigation system for mitigating potential racial injustice during law enforcement interactions.

FIG. 7 is a flow diagram illustrating an embodiment of a routine implemented by a mitigation system for mitigating potential racial injustice during law enforcement interactions.

### DETAILED DESCRIPTION

The present inventive concept emerges in response to issues associated with vehicular law enforcement interactions and driver awareness. Traffic stops and other law enforcement interactions often pose stressful situations, escalating into potentially dangerous scenarios, especially for marginalized communities such as communities of color. These interactions can lead to instances of racial injustice, occasionally resulting in tragic outcomes. Compounding these interactions are limited understanding of applicable laws and regulations, and communication barriers arising from language differences. Current systems inadequately address these concerns, underscoring a need for improved transparency and accountability.

While recording devices have increasingly been adopted to enhance transparency and evidence preservation during such interactions, the integration of these features within vehicle systems remains underdeveloped. Additionally, a significant number of drivers lack awareness about their rights, the specific laws applicable within their jurisdiction, and local traffic patterns, all of which can lead to unintended law enforcement interactions. Moreover, drivers often unknowingly engage in risky behaviors due to unfamiliarity with the presence of law enforcement officials in certain areas. This lack of information may lead to enforcement actions, revealing a gap in driver awareness and understanding of potential legal risks.

In response to these and other challenges, the present inventive concepts introduce mitigation systems and methods for empowering individuals in their interactions with law enforcement. A mitigation system in accordance with the inventive concepts can inform individuals about potential enforcement actions resulting from their behavior or common in their geographic location, fostering informed decision-making and reducing the likelihood of unfavorable interactions with law enforcement. During law enforcement interactions, the mitigation system can provide relevant legal information, ensure transparency through recording the law enforcement interaction, and facilitate communication with legal professionals and support networks. By integrating these capabilities, the mitigation system can mitigate potential issues during these interactions, including racial injustice, and promotes a more transparent, fair, and informed experience for all parties involved.

Disclosed herein is a mitigation system that can inform individuals about potential enforcement actions associated with their behavior or specific geographic location. By monitoring operating parameters, such as geographic location, and analyzing enforcement action data from a comprehensive database, the mitigation system can determine the likelihood of encountering enforcement actions. This analysis can combine various factors, including historical enforcement records and real-time vehicle operation data, to estimate the likelihood of potential interactions with law enforcement.

This predictive capability can enable individuals to have a clearer understanding of the risk of encountering law enforcement actions while driving. Furthermore, it can help them make informed decisions and take appropriate measures to reduce the likelihood of negative interactions. For example, by alerting individuals when their behavior parameters exceed predefined thresholds associated with enforcement actions, the mitigation system can empower them to adjust their driving habits and comply with traffic regulations more effectively. This proactive approach can foster a safer driving environment, promote compliance with the law, and reduce the potential for unfavorable interactions with law enforcement officials.

In some cases, the mitigation system can leverage machine learning algorithms or geospatial data analysis to inform individuals about potential enforcement actions associated with their behavior and geographic location. For example, the mitigation system can monitor behavior parameters and access a database of enforcement actions within a predetermined area surrounding the individual's location. Using advanced technologies, such as machine learning, the mitigation system can analyze the data to determine the likelihood of encountering enforcement actions. By examining behavior parameters and comparing them to predefined criteria associated with enforcement actions, the mitigation system can identify instances where the operating parameters can exceed the thresholds. In such cases, the mitigation system can notify the individual, allowing the individual to take appropriate measures and make informed decisions to maintain a safer and more predictable environment. This approach can advantageously empower individuals with the knowledge and awareness needed to adjust their behavior and reduce the risk of adverse interactions with law enforcement, promoting a sense of security and confidence on the road.

Disclosed herein is a mitigation system that can mitigate potential racial injustice during police interactions. The mitigation system can monitor operating parameters of a user's vehicle, including its geographic location, and detect conditions indicative of an impending law enforcement interaction. Upon detection, the mitigation system can activate recording devices, such as integrated vehicle cameras and an audio capture device, to capture image and audio data during the law enforcement interaction. The mitigation system can obtain jurisdiction-specific legal information based on the vehicle's geographic location and identify and initiate communication with a legal aid professional and a predetermined group of contacts.

The mitigation system can include a display interface within the vehicle or on a mobile communication device. The interface can present jurisdiction-specific legal information, communication channels with the legal aid professional, or communication channels with the predetermined group of contacts. During the law enforcement interaction, the mitigation system can dynamically update the presented information based on the law enforcement interaction, such as spoken words of or actions made by the officer captured by the audio or image capture devices.

### Environment Overview

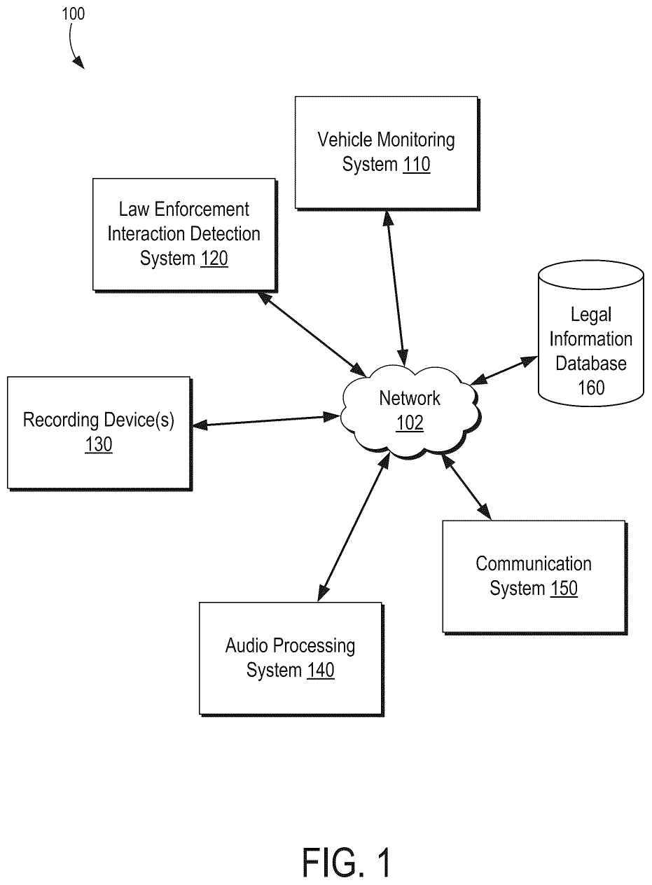

FIG. 1 illustrates an embodiment of a mitigation system 100 for mitigating potential racial or other injustice during law enforcement interactions. The mitigation system 100 includes an interconnected network of systems and components including, but not limited to, a vehicle monitoring system 110, a law enforcement interaction detection system 120, one or more recording devices 130, an audio processing system 140, a communication system 150, and a legal information database 160.

Any of the foregoing components or systems of the mitigation system 100 can communicate with each other via network 102, which can be any type of communication network, such as a wide area network (WAN), local area network (LAN), cellular network (e.g., LTE, HSPA, 3G, and other cellular technologies), ad hoc network, satellite network, wired network, or wireless network. In some embodiments, the network 102 can include the Internet. Although only one network 102 is illustrated, multiple distinct and/or distributed networks 102 may exist.

The vehicle monitoring system 110 can monitor and process various operating parameters. The vehicle monitoring system 110 can include onboard or remote sensors and external data inputs, facilitating the surveillance of the vehicle's operational and environmental state. The vehicle monitoring system 110 can monitor metrics such as the vehicle's speed, direction, or geospatial location. For example, the speed of the vehicle can be determined using a standard speed sensor located within the vehicle's drivetrain, while a GPS sensor in the vehicle can offer real-time geospatial location and direction. The vehicle monitoring system 110 can monitor factors like engine performance, brake status, or fuel efficiency. Additionally, the vehicle monitoring system 110 can process data related to lane-keeping, adaptive cruise control status, or alerts from collision avoidance systems. Further, the vehicle monitoring system 110 can incorporate external conditions such as road conditions, weather, or traffic patterns. Data for these parameters can be obtained from external sources such as meteorological services or traffic data from municipal databases or other vehicles.

The operating parameters obtained or monitored by the vehicle monitoring system 110 can include one or more of vehicle status parameters, vehicle performance metrics, environmental conditions, or safety feature data. Vehicle status parameters can include, but are not limited to, speed (e.g., 65 mph), direction (e.g., northbound), geospatial location (e.g., 37.7749° N, 122.4194° W), exterior lighting status (e.g., headlights on), turn signal usage (e.g., left turn signal activated), windshield wiper operation (e.g., wipers active at medium speed), seatbelt usage (e.g., driver's seatbelt fastened), door lock status (e.g., all doors locked), or vehicle weight (e.g., 1500 kg). Vehicle performance metrics can include, but are not limited to, parameters such as revolutions per minute (e.g., 3000 RPM), engine temperature (e.g., 90° C.), fuel efficiency (e.g., 30 miles per gallon), tire pressure (e.g., 32 psi), or brake status (e.g., brakes engaged). Environmental conditions monitored can include, but are not limited to, ambient light conditions (e.g., low light), road conditions (e.g., wet pavement), weather data (e.g., rain), or traffic patterns (e.g., heavy traffic). Safety feature data can include, but are not limited to, lane-keeping data (e.g., vehicle within lane boundaries), adaptive cruise control status (e.g., cruise control engaged at 60 mph), alerts from collision avoidance systems (e.g., alert triggered due to obstacle detected), or airbag deployment status (e.g., airbags not deployed).

The operating parameters can provide a picture of the vehicle's operational status, performance, environmental context, or safety status, which can be used for interpreting or responding to law enforcement interactions. For example, by presenting real-time speed data, the mitigation system 100 can inform the driver if they are exceeding the speed limit, potentially preventing law enforcement interactions. As another example, geospatial data can inform the driver about their jurisdiction, aiding them in adhering to specific local laws and regulations. The vehicle monitoring system 110 can thus aid in reducing oversights and maintaining compliance with traffic laws. Furthermore, the vehicle monitoring system 110 can serve a preventive role by alerting the driver to possible infractions, such as exceeding speed limits, thereby mitigating the likelihood of law enforcement interactions.

As mentioned, the operating parameters of the vehicle monitoring system 110 can include the vehicle's current location. This determination can be made through the integration of positioning technologies. For example, the mitigation system 100 may utilize global positioning systems (GPS), Russia's Global Navigation Satellite System (GLONASS), Europe's Galileo, or China's BeiDou Navigation Satellite System, among others, to ascertain the vehicle's precise geographic coordinates. As described herein, the geospatial data can be used as an input in conjunction with the legal information database 160. For instance, acquired geographic coordinates can serve as a query parameter for the legal information database 160. This query can enable the mitigation system 100 to fetch the jurisdiction-specific legal information in accordance with the vehicle's current location. In some cases, this process equips the driver with legal information that is relevant and accurate, as per their current geospatial context and potential law enforcement interactions.

The law enforcement interaction detection system 120 identifies potential indicators of a forthcoming law enforcement interaction. These indicators can include, but are not limited to, the proximity of an emergency vehicle, the activation of emergency lights, or distinct audible signals such as sirens. Furthermore, the law enforcement interaction detection system 120 can incorporate data from connected systems such as vehicle-to-vehicle (V2V) or vehicle-to-infrastructure (V2I) communication networks. For instance, the law enforcement interaction detection system 120 can seamlessly integrate with community-driven platforms such as Waze, which empowers its user community to report a broad spectrum of traffic-related incidents including the immediate location of law enforcement officers. The detection system 120 can leverage various technologies for detection, including radar, LIDAR, optical cameras, and infrared sensors, among others. These sources can collectively amplify the mitigation system's situational awareness and responsiveness, increasing the accuracy of its predictions and providing the user with timely alerts.

Upon detecting such indicators, the law enforcement interaction detection system 120 can initiate a series of one or more responsive actions. These actions can include, but are not limited to, activating one or more integrated or remote recording devices 130 to capture image and audio data, signaling the vehicle monitoring system 110 to record the vehicle's current state, or notifying the communication system 150 to prepare for possible communication with legal aid professionals. In some cases, the actions include activating a mitigation app running on a mobile device. In some cases, the actions include alerting the driver of the detected law enforcement interaction, thus giving the driver the opportunity to prepare themselves accordingly. For instance, the law enforcement interaction detection system 120 can display an alert on the vehicle's infotainment center, providing instructions or potentially calming the driver, thereby aiding in the de-escalation of the situation.

In some cases, the law enforcement interaction detection system 120 can maintain a log of detected interactions, contributing to a historical record that can be referred to in the future. For example, these logs could be used to identify frequent zones of law enforcement interaction, thereby enabling the driver to exercise extra caution in these areas. Thus, the law enforcement interaction detection system 120 can play a role in identifying, preparing for, or managing law enforcement interactions, enhancing the safety and legal protection of the driver and passengers within the vehicle.

The recording devices 130 can include a set of integrated or remote vehicle cameras or audio capture devices. These devices can be positioned to capture information within and/or outside the vehicle to provide coverage of interior and/or exterior zones of the vehicle. For instance, cameras can be integrated in the front or rear of the vehicle, or within the cabin to capture the driver's area and/or the back seats. Similarly, audio capture devices can be located in a position that enables audible capture of conversations within or outside of the vehicle. In certain implementations, the recording devices 130 can also extend to incorporate the cameras and microphones on the driver's or other users' mobile devices. For example, the mitigation system 100 can have permissions to activate the camera and microphone of a smartphone via an associated app. This can provide additional angles and vantage points, enhancing the coverage and quality of the captured data.

Upon detection of a potential law enforcement interaction by the law enforcement interaction detection system 120, the recording devices 130 can be automatedly activated. This activation can ensure that the recording begins in a timely manner, capturing the law enforcement interaction at or around its onset. The recording devices 130 can capture and store image and audio data, thereby creating an objective record of the law enforcement interaction.

In some cases, captured video footage can display the actions of the driver, passenger(s), or the law enforcement officer(s), while the audio can record at least a portion of the conversation between them. In some cases, the recording devices 130 can be linked to the vehicle's onboard storage system or a secure cloud-based storage solution. This can ensure that the recorded data is stored and readily accessible for future reference. For instance, this data could be used to review the legality of the law enforcement interaction, provide evidence in case of disputes, or support legal proceedings if necessary.

The recording devices 130 can capture and preserve a factual record of law enforcement interactions, which can serve to protect the rights and interests of the driver and passengers. Furthermore, the integration of mobile device recording capabilities can provide a flexible, robust, and redundant method of recording, ensuring that even in the event of a failure or obstruction of one of the vehicle's integrated cameras, the law enforcement interaction can still be adequately documented.

The audio processing system 140 can be implemented as an application of audio and linguistic technologies designed to facilitate a more informed interaction with law enforcement. For example, the audio processing system 140 can capture and process spoken words, with a particular focus on those uttered by the law enforcement officer during an interaction. The audio processing system 140 can leverage the recording devices 130, or, in some cases, it can tap into the driver's mobile device's audio input, given necessary permissions, to effectively capture audio data.

In processing this audio data, the audio processing system 140 can employ speech recognition and natural language processing algorithms. These algorithms can transcribe spoken words into text, and perform an analysis of the transcribed content to glean context, intent, or specific legal terms. In some cases, the audio processing system 140 can do this using machine learning techniques. This dynamic interpretation of the officer's speech can serve to update the displayed legal information in real-time, maintaining the relevance of the displayed legal information throughout the law enforcement interaction.

Consider a scenario in which the audio processing system 140 identifies an officer mentioning a specific traffic violation, such as running a stop sign. Upon recognition, the audio processing system 140 can fetch pertinent legal information from the legal information database 160. This information, which can include penalties for or requirements of the mentioned violation within the current jurisdiction, can then be displayed to the driver. By maintaining this level of dynamic update, the audio processing system 140 can ensure the driver is equipped with the most relevant and accurate legal information as the law enforcement interaction unfolds.

The communication system 150 can enable one or multiple communication channels to facilitate real-time, direct contact in varying contexts. The operational features of the communication system 150 can include, but are not limited to, a legal-aid communication channel and a contacts communication channel.

The legal-aid communication channel can provide a conduit for real-time communication between the driver and a legal aid professional. This could include individuals such as attorneys, paralegals, or local law experts. In the event of a law enforcement interaction, this channel can be activated, offering the driver concurrent access to professional legal assistance. The advice and guidance obtained through this channel can be invaluable during these stressful situations, ensuring the driver's rights are upheld and respected throughout the law enforcement interaction.

The contacts communication channel can provide the driver with lines of communication with a chosen support network, which could include family members, friends, or legal representatives. This communication can be facilitated through various means such as text messages, voice calls, or live video communication, ensuring the driver is not isolated during a potential law enforcement interaction. The contacts communication channel can foster a sense of security and support, maintaining a connection to a trusted network throughout the entirety of the law enforcement interaction.

The legal information database 160 can be a repository of legal information. The legal information can include national or state-level laws and regulations, or commonly accepted legal principles and practices that transcend specific jurisdictions. In addition or alternatively, the legal information can include various aspects of traffic law, including but not limited to, driving regulations, permissible and non-permissible actions, penalties associated with different violations, or basic civil rights during a law enforcement interaction. The legal information can extend to include specific procedural details about law enforcement protocols in different jurisdictions. In some cases, the legal information is jurisdiction specific. For example, jurisdiction-specific legal information can include variations in speed limits, rules about turn signals, protocols around sobriety tests, local restrictions on phone usage while driving, and nuances in rights regarding search and seizure during traffic stops.

The legal information database 160 can engage in communication with the vehicle monitoring system 110. For example, using the geospatial data received from the monitoring system 110, the legal information database 160 can ascertain the pertinent jurisdiction and subsequently retrieve the matching legal data. Algorithms specialized in search functions, methods for indexing, or protocols for data retrieval may facilitate this targeted extraction of information.

The legal information database 160 can accommodate routine updates, thereby ensuring that it consistently includes current and accurate legal information. For example, scheduled updates can be applied that reflect alterations to laws and regulations spanning applicable jurisdictions. The process of updating can be automated and can employ technologies such as web scraping, integration with legal information application programming interfaces (APIs), or data feeds from approved legal information providers. By staying up-to-date on the latest legal amendments, the legal information database 160 can ensure that drivers have access to the most recent and relevant legal knowledge, thereby enhancing their readiness during a law enforcement interaction.

In certain implementations, the legal information database 160 can feature an interface accessible to legal professionals. This interface can provide these professionals with the ability to review, update, and validate the accuracy of the stored information. By doing so, it can ensure that the information remains not just up to date, but also reliable and accurate, thus providing drivers with dependable legal guidance.

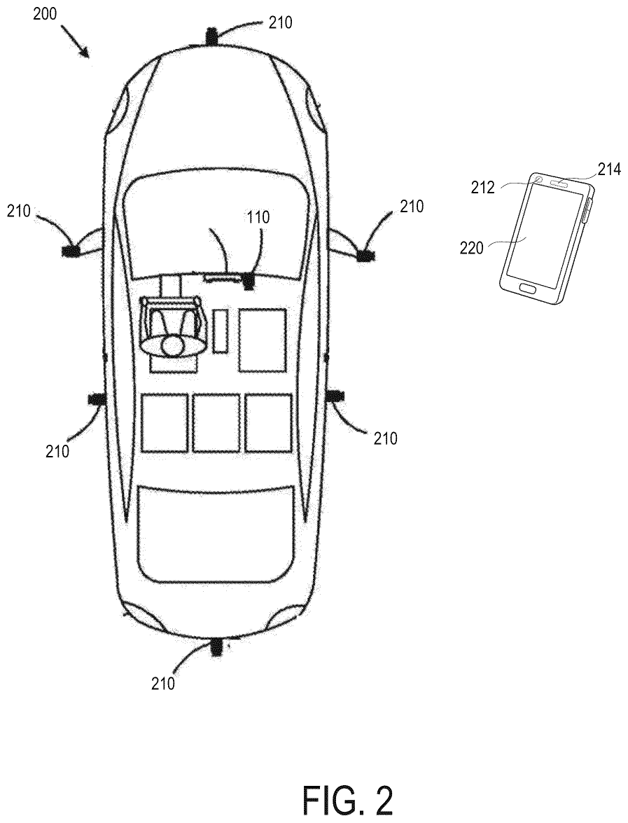

FIG. 2 illustrates a diagram of a vehicle 200 equipped with integrated cameras and/or audio capture devices 210, emphasizing example placement and coverage of the devices during a law enforcement interaction, in accordance with the inventive concept.

The vehicle 200 as depicted in FIG. 2, showcases an embodiment of the inventive concept where integrated cameras and/or audio capture devices 210 are strategically positioned to provide comprehensive coverage of the vehicle's interior and exterior during a law enforcement interaction. Maintaining the aesthetics and functionality of the vehicle, these integrated cameras and/or audio capture devices 210 can ensure good data capture. The integrated cameras and/or audio capture devices 210 can include seven cameras in total, six for external coverage and one for the interior cabin.

Exterior coverage can be provided by one or more of the following cameras: a forward-facing camera that is integrated into the vehicle's front grille or dashboard, designed to capture the road ahead and the driver's actions; a rear-facing camera (e.g., integrated into the rearview mirror or the rear of the vehicle) for capturing the view behind the vehicle and/or any actions of law enforcement personnel approaching from the rear; a side-facing camera placed in on the vehicle's side, providing coverage of a sides of the vehicle; or a side mirror camera, positioned to provide an extended view of the vehicle's surroundings.

The interior of the vehicle 200 can be covered by a camera that is located or integrated within the cabin. This camera can be focused on the driver's seat, passenger seats, and/or rear seats, capturing interactions between the driver, passengers, and law enforcement officers during an interaction. In some scenarios, a camera 212 and/or microphone 214 of a mobile device 220 (e.g., a driver's cell phone), can be employed (e.g., to supplement the captured data).

The audio capture devices can be positioned to capture conversations within and/or outside the vehicle. These devices can be located, for example, in the ceiling or dashboard of the vehicle, near the driver or passenger seats. In some cases, exterior microphones can be incorporated into the vehicle's body to capture external sounds, such as sirens or verbal exchanges between the driver and law enforcement officers.

In some cases, the coverage zones of the cameras and/or audio capture devices 210 can overlap to ensure no blind spots, enabling a substantially comprehensive and objective record of the law enforcement interaction. These devices can be connected to the vehicle's onboard computing system or a remote server, allowing for real-time processing and storage of the captured data. In some instances, the cameras and audio capture devices 210 can be activated manually by the driver or automatically by a law enforcement interaction detection system 120.

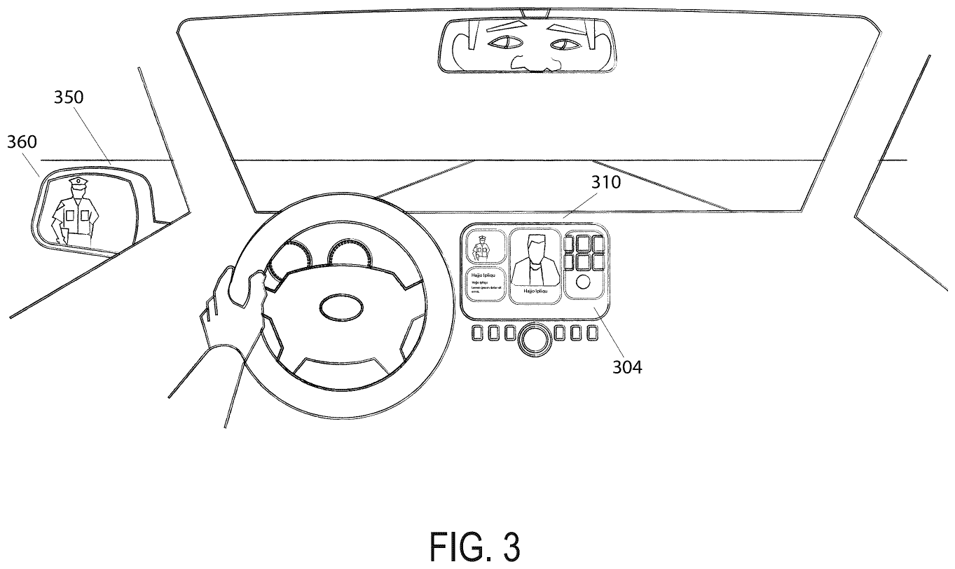

FIG. 3 is a schematic representation of a mitigation system 310, integrated into an infotainment center 304 of vehicle 302 and engaged during a law enforcement interaction. The mitigation system can be an embodiment of the mitigation system 100 of FIG. 1. In this depiction, a driver is situated within the vehicle's driver's seat, having been pulled over by a law enforcement officer 360. The approaching officer 360 can be visually traced in the reflective surface of the driver's side mirror 350. In some cases, this identification of the officer 360 signals an initiation of a law enforcement interaction.

As depicted, the law enforcement interaction mitigation system 310 can be integrated within the vehicle's infotainment center 304. The positioning ca serve as a hub, equipping drivers with information and secure communication channels throughout the progression of the law enforcement interaction. In specific scenarios, the law enforcement interaction mitigation system 310 can dynamically display a range of information aimed at enhancing driver preparedness and response during the law enforcement interaction.

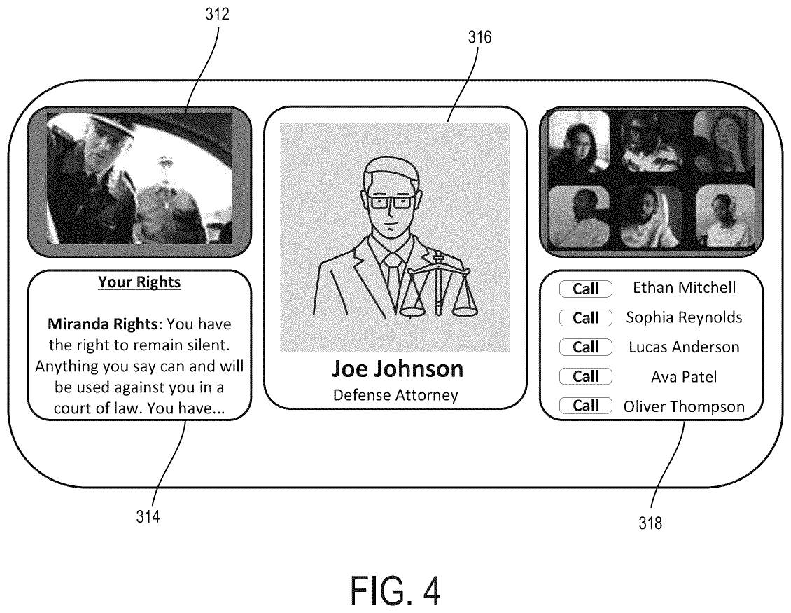

FIG. 4 illustrates an example graphical user interface (GUI) 400 of a vehicle-based system for mitigating potential racial injustice during law enforcement interactions. As shown, the on the GUI can include, but is not limited to, a live video feed 312 capturing real-time images of the law enforcement interaction, jurisdiction-specific legal information 314, a direct legal-aid communication channel 316, a contacts communication channel 318, or operating parameters (not shown) of the vehicle. These features can empower the driver with a greater sense of control and understanding during law enforcement interactions.

The live feed 312 can be produced by a camera (e.g., a recording device 130 shown), which may take the form of an integrated vehicle camera, a camera embedded in a mobile device, or any other suitable camera. The camera can provide real-time video documentation of the ongoing law enforcement interaction, or before or after the law enforcement interaction. The camera feed 312 can empower the driver with the capability to actively monitor, digitally record, or live-stream the law enforcement interaction, thereby fostering heightened transparency and accountability during the law enforcement interaction. The live feed 312 can vary across embodiments. For example, as shown, the live feed 312 can deliver a driver-centric perspective, substantially mirroring a view from the driver's window and offering a visual representation of the unfolding interaction. Additional or alternative feeds may include, but are not limited to, views from cabin cameras, rearview cameras, passenger-side windows, or a wide-angle perspective that fully or partially envelopes the vehicle's immediate surroundings, facilitating larger situational awareness during law enforcement interactions.

The jurisdiction-specific legal information 314 can provide a contextually relevant legal framework for the driver. For example, jurisdiction-specific legal information 314 can include an array of legal knowledge, including but not limited to, local traffic laws, specific rights during police interactions, or relevant legal precedents. The jurisdiction-specific legal information 314 presented on the display may be dynamically updated over time to intelligently tailor the displayed legal information, aligning it to the current geographic location of the vehicle and/or the specific characteristics of the unfolding law enforcement interaction. In this way, the mitigation system can ensure that the driver is informed and empowered with pertinent and applicable legal knowledge. This dynamic adaptation of legal information to situational context can augment the driver's understanding and ability to navigate the complexities of the law enforcement interaction effectively and confidently.

The legal-aid communication channel 316 can provide the driver with a conduit for direct, real-time communication with a legal aid professional, such as an attorney, paralegal, or local law expert. This access to professional legal assistance can offer invaluable advice in the heat of the moment, while concurrently ensuring the driver's rights remain upheld and respected throughout the law enforcement interaction.

The contacts communication channel 318 can provide the driver with open lines of communication with a chosen support network, which could include family members, friends, or legal representatives. Whether through text messages, voice calls, or live video communication, the contacts communication channel 318 can ensure the driver is not isolated during the law enforcement interaction, thereby fostering a sense of security and support throughout the entirety of the law enforcement interaction.

The operating parameters can serve as a dynamic snapshot of the vehicle's current or prior state, or its surroundings. These operating parameters can include any of the operating parameters described herein. The operating parameters can advantageously contribute to a more informed and proactive response during a law enforcement interaction, while also aiding to prevent such interactions in the first place. For example, by keeping the driver aware of their speed, or alerting them to potential driving infractions, the mitigation system can aid in limiting oversights and help maintain compliance with traffic laws, effectively reducing the likelihood of law enforcement interactions.

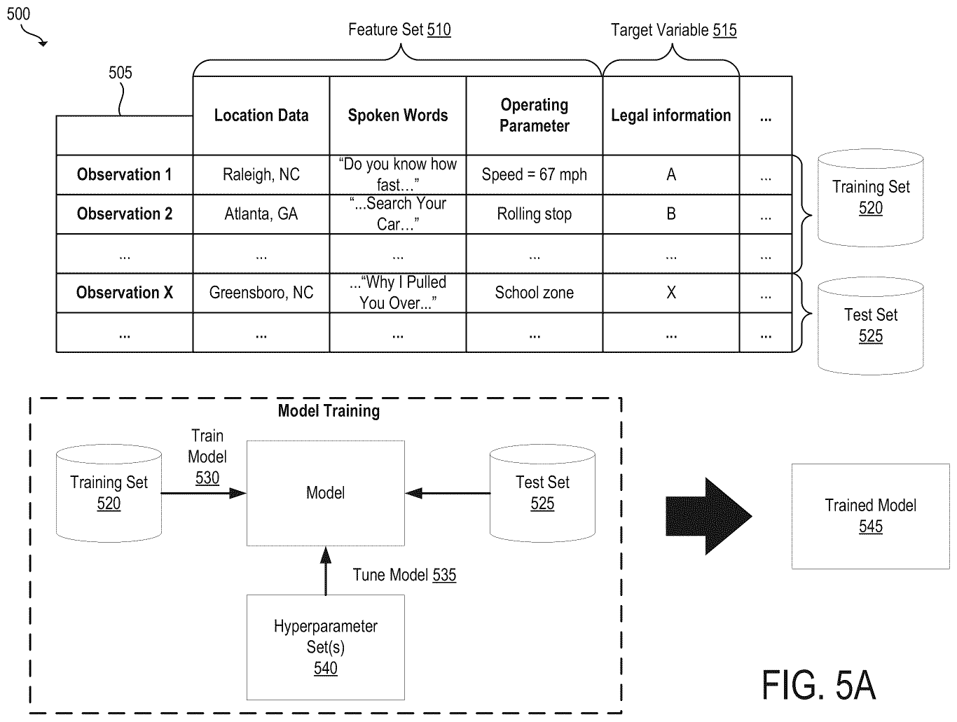

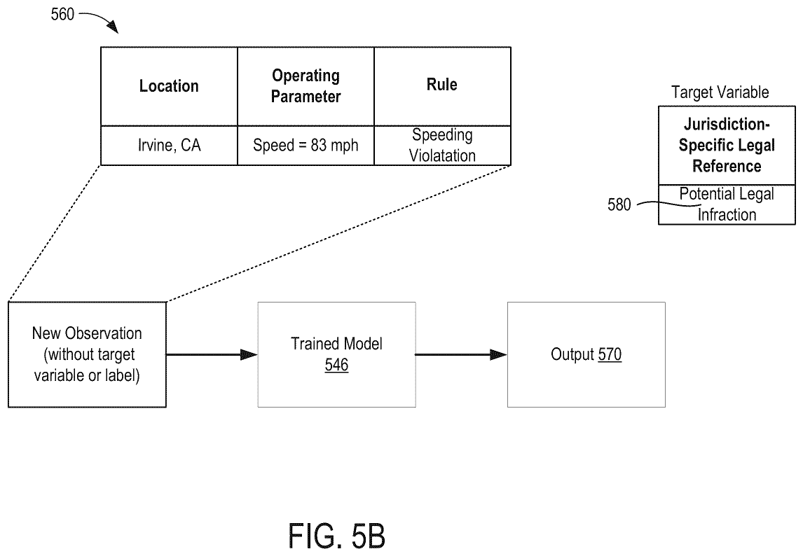

FIG. 5A is a diagram illustrating an example of training an advanced language model 500, in accordance with the present disclosure. The advanced training language 500 may represent various forms of artificial intelligence techniques, including but not limited to generative AI models, machine learning models, or Generative Pretrained Transformer (GPT)-like technologies. For example, the advanced language model 500 can rely on distinct architectures and training processes, leveraging large, diverse datasets to optimize its predictive or generative capabilities. The advanced language model 500 may include or may be included in a computing device, a server, a cloud computing environment, or the like, such as the mitigation system 100 described herein.

As shown by reference number 505, an advanced language model may be trained using a set of observations. The set of observations may be obtained and/or input from historical data, such as data gathered during one or more processes described herein. For example, the set of observations may include data gathered from the mitigation system 100, as described elsewhere herein. In some implementations, the advanced language model 500 may receive a set of observations (e.g., as input) from the mitigation system 100 or from a storage device.

As shown by reference number 510, a feature set may be derived from the set of observations. The feature set may include a set of variables. A variable may be referred to as a feature. A specific observation may include a set of variable values corresponding to the set of variables. A set of variable values may be specific to an observation. In some cases, different observations may be associated with different sets of variable values, sometimes referred to as feature values.

In some implementations, the advanced language model 500 may determine variables for a set of observations and/or variable values for a specific observation based on input received from mitigation system 100. For example, the advanced language model 500 may identify a feature set (e.g., one or more features and/or corresponding feature values) from structured data input to the advanced language model 500, such as by extracting data from a particular column of a table, extracting data from a particular field of a form and/or a message, and/or extracting data received in a structured data format. Additionally, or alternatively, the advanced language model 500 may receive input from an operator to determine features and/or feature values.

In some implementations, the advanced language model 500 may perform natural language processing and/or another feature identification technique to extract features (e.g., variables) and/or feature values (e.g., variable values) from text (e.g., unstructured data) input to the advanced language model 500, such as by identifying keywords and/or values associated with those keywords from the text.

As an example, a feature set for a set of observations may include a first feature of Location Data, a second feature of Spoken Words, a third feature of Operating Parameter, and so on. As shown, for a first observation, the first feature may have a value of “Raleigh, NC”, the second feature may have a value of “Do you know how fast . . . ”, the third feature may have a value of “Speed=67 mph”, and so on. These features and feature values are provided as examples and may differ in other examples. In some implementations, the advanced language model 500 may pre-process and/or perform dimensionality reduction to reduce the feature set and/or combine features of the feature set to a minimum feature set. An advanced language model may be trained on the minimum feature set, thereby conserving resources of the advanced language model 500 (e.g., processing resources and/or memory resources) used to train the advanced language model.

The set of observations may be associated with a target variable 515. The target variable 515 may represent a variable having a numeric value (e.g., an integer value or a floating point value), may represent a variable having a numeric value that falls within a range of values or has some discrete possible values, may represent a variable that is selectable from one of multiple options (e.g., one of multiples classes, classifications, or labels), or may represent a variable having a Boolean value (e.g., 0 or 5, True or False, Yes or No), among other examples. A target variable may be associated with a target variable value, and a target variable value may be specific to an observation. In some cases, different observations may be associated with different target variable values. In example 500, the target variable 515 is legal information, such as the jurisdiction-specific legal information described herein.

The feature set and target variable outlined previously are merely illustrative, with different situations presenting their own unique variations. Taking “Legal Information” as a target variable, for instance, the feature set could encompass one or more legal rights pertinent to specific city jurisdictions. These rights could relate to rules governing traffic stops in particular cities. In San Francisco, California, drivers have the right to refuse a vehicle search unless the police officer has a warrant, probable cause, or their explicit consent. Phoenix, Arizona, operates under the “Move Over Law,” which mandates drivers to move over one lane or slow down when passing a stopped emergency vehicle with flashing lights. In contrast, Chicago, Illinois, enforces “Scott's Law” or the “Move Over” law, requiring drivers to slow down and change lanes when approaching any vehicle with hazard lights activated. Finally, Boston, Massachusetts, adheres to the “Wipers On, Lights On” law, whereby drivers must activate their headlights when their windshield wipers are in use. These city-specific legal rights vary and form part of the feature set that informs the “Legal Information” target variable.

The target variable may represent a value that an advanced language model is being trained to predict, and the feature set may represent the variables that are input to a trained advanced language model to predict a value for the target variable. The set of observations may include target variable values so that the advanced language model can be trained to recognize patterns in the feature set that lead to a target variable value. an advanced language model that is trained to predict a target variable value may be referred to as a supervised learning model or a predictive model. When the target variable is associated with continuous target variable values (e.g., a range of numbers), the advanced language model may employ a regression technique. When the target variable is associated with categorical target variable values (e.g., classes or labels), the advanced language model may employ a classification technique.

In some implementations, the advanced language model may be trained on a set of observations that do not include a target variable (or that include a target variable, but the advanced language model is not being executed to predict the target variable). This may be referred to as an unsupervised learning model, an automated data analysis model, or an automated signal extraction model. In this case, the advanced language model may learn patterns from the set of observations without labeling or supervision, and may provide output that indicates such patterns, such as by using clustering and/or association to identify related groups of items within the set of observations.

As further shown, the advanced language model 500 may partition the set of observations into a training set 520 that includes a first subset of observations of the set of observations, and a test set 525 that includes a second subset of observations of the set of observations. The training set 520 may be used to train (e.g., fit or tune) the advanced language model, while the test set 525 may be used to evaluate an advanced language model that is trained using the training set 520. For example, for supervised learning, the test set 525 may be used for initial model training using the first subset of observations, and the test set 525 may be used to test whether the trained model accurately predicts target variables in the second subset of observations. In some implementations, the advanced language model 500 may partition the set of observations into the training set 520 and the test set 525 by including a first portion or a first percentage of the set of observations in the training set 520 (e.g., 75%, 80%, or 85%, among other examples) and including a second portion or a second percentage of the set of observations in the test set 525 (e.g., 25%, 20%, or 55%, among other examples). In some implementations, the advanced language model 500 may randomly select observations to be included in the training set 520 and/or the test set 525.

As shown by reference number 530, the advanced language model 500 may train an advanced language model using the training set 520. This training may include executing, by the advanced language model 500, a machine learning algorithm to determine a set of model parameters based on the training set 520. In some implementations, the machine learning algorithm may include a regression algorithm (e.g., linear regression or logistic regression), which may include a regularized regression algorithm (e.g., Lasso regression, Ridge regression, or Elastic-Net regression). Additionally, or alternatively, the machine learning algorithm may include a decision tree algorithm, which may include a tree ensemble algorithm (e.g., generated using bagging and/or boosting), a random forest algorithm, or a boosted trees algorithm. A model parameter may include an attribute of an advanced language model that is learned from data input into the model (e.g., the training set 520). For example, for a regression algorithm, a model parameter may include a regression coefficient (e.g., a weight). For a decision tree algorithm, a model parameter may include a decision tree split location, as an example.

As shown by reference number 535, the advanced language model 500 may use one or more hyperparameter sets 540 to tune the advanced language model. A hyperparameter may include a structural parameter that controls execution of a machine learning algorithm by the advanced language model 500, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the advanced language model to the training set 520. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

To train an advanced language model, the advanced language model 500 may identify a set of machine learning algorithms to be trained (e.g., based on operator input that identifies the one or more machine learning algorithms and/or based on random selection of a set of machine learning algorithms), and may train the set of machine learning algorithms (e.g., independently for each machine learning algorithm in the set) using the training set 520. The advanced language model 500 may tune each machine learning algorithm using one or more hyperparameter sets 540 (e.g., based on operator input that identifies hyperparameter sets 540 to be used and/or based on randomly generating hyperparameter values). The advanced language model 500 may train a particular advanced language model using a specific machine learning algorithm and a corresponding hyperparameter set 540. In some implementations, the advanced language model 500 may train multiple advanced language models to generate a set of model parameters for each advanced language model, where each advanced language model corresponds to a different combination of a machine learning algorithm and a hyperparameter set 540 for that machine learning algorithm.

In some implementations, the advanced language model 500 may perform cross-validation when training an advanced language model. Cross validation can be used to obtain a reliable estimate of advanced language model performance using only the training set 520, and without using the test set 525, such as by splitting the training set 520 into a number of groups (e.g., based on operator input that identifies the number of groups and/or based on randomly selecting a number of groups) and using those groups to estimate model performance. For example, using k-fold cross-validation, observations in the training set 520 may be split into k groups (e.g., in order or at random). For a training procedure, one group may be marked as a hold-out group, and the remaining groups may be marked as training groups. For the training procedure, the advanced language model 500 may train an advanced language model on the training groups and then test the advanced language model on the hold-out group to generate a cross-validation score. The advanced language model 500 may repeat this training procedure using different hold-out groups and different test groups to generate a cross-validation score for each training procedure. In some implementations, the advanced language model 500 may independently train the advanced language model k times, with each individual group being used as a hold-out group once and being used as a training group k−1 times. The advanced language model 500 may combine the cross-validation scores for each training procedure to generate an overall cross-validation score for the advanced language model. The overall cross-validation score may include, for example, an average cross-validation score (e.g., across all training procedures), a standard deviation across cross-validation scores, or a standard error across cross-validation scores.

In some implementations, the advanced language model 500 may perform cross-validation when training an advanced language model by splitting the training set into a number of groups (e.g., based on operator input that identifies the number of groups and/or based on randomly selecting a number of groups). The advanced language model 500 may perform multiple training procedures and may generate a cross-validation score for each training procedure. The advanced language model 500 may generate an overall cross-validation score for each hyperparameter set 540 associated with a particular machine learning algorithm. The advanced language model 500 may compare the overall cross-validation scores for different hyperparameter sets 540 associated with the particular machine learning algorithm, and may select the hyperparameter set 540 with the best (e.g., highest accuracy, lowest error, or closest to a desired threshold) overall cross-validation score for training the advanced language model. The advanced language model 500 may then train the advanced language model using the selected hyperparameter set 540, without cross-validation (e.g., using all of data in the training set 520 without any hold-out groups), to generate a single advanced language model for a particular machine learning algorithm. The advanced language model 500 may then test this advanced language model using the test set 525 to generate a performance score, such as a mean squared error (e.g., for regression), a mean absolute error (e.g., for regression), or an area under receiver operating characteristic curve (e.g., for classification). If the advanced language model performs adequately (e.g., with a performance score that satisfies a threshold), then the advanced language model 500 may store that advanced language model as a trained advanced language model 545 to be used to analyze new observations, as described below in connection with FIG. 2.

In some implementations, the advanced language model 500 may perform cross-validation, as described above, for multiple machine learning algorithms (e.g., independently), such as a regularized regression algorithm, different types of regularized regression algorithms, a decision tree algorithm, or different types of decision tree algorithms. Based on performing cross-validation for multiple machine learning algorithms, the advanced language model 500 may generate multiple advanced language models, where each advanced language model has the best overall cross-validation score for a corresponding machine learning algorithm. The advanced language model 500 may then train each advanced language model using the entire training set 520 (e.g., without cross-validation), and may test each advanced language model using the test set 525 to generate a corresponding performance score for each advanced language model. The advanced language model may compare the performance scores for each advanced language model, and may select the advanced language model with the best (e.g., highest accuracy, lowest error, or closest to a desired threshold) performance score as the trained advanced language model 545.

As indicated above, FIG. 5A is provided as an example. Other examples may differ from what is described in connection with FIG. 5A. For example, the advanced language model may be trained using a different process than what is described in connection with FIG. 5A. Additionally, or alternatively, the advanced language model may employ a different machine learning algorithm than what is described in connection with FIG. 5A, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

FIG. 5B is a diagram illustrating an example of applying a trained advanced language model to a new observation associated with identifying jurisdiction-specific legal information. The new observation may be input to a machine learning system that stores a trained model 546. In some implementations, the trained model 546 may be the trained advanced language model 545 described above in connection with FIG. 5. The advanced language model 500 may include or may be included in a computing device, a server, or a cloud computing environment, such as the mitigation system 100.

As shown by reference number 560, the advanced language model 500 may receive a new observation (or a set of new observations), and may input the new observation to the trained model 546. As shown, the new observation may include a first feature of Location Data, a second feature of Operating Parameter, and a third feature of Rule. The advanced language model 500 may apply the trained model 546 to the new observation to generate an output (e.g., a result). The type of output may depend on the type of advanced language model and/or the type of machine learning task being performed. For example, the output may include a predicted (e.g., estimated) value of target variable (e.g., a value within a continuous range of values, a discrete value, a label, a class, or a classification), such as when supervised learning is employed. Additionally, or alternatively, the output may include information that identifies a cluster to which the new observation belongs and/or information that indicates a degree of similarity between the new observation and one or more prior observations (e.g., which may have previously been new observations input to the advanced language model and/or observations used to train the advanced language model), such as when unsupervised learning is employed.

In some implementations, the trained model 545 may predict a value of ‘Potential Legal Infraction’ for the target variable ‘Jurisdiction-Specific Legal Reference’ for a new observation, as shown by reference number 580. Based on this prediction, for instance, if the value is labeled as ‘Speeding Violation’ or if it meets a risk threshold, the advanced language model 500 may provide a recommendation such as ‘You were likely stopped for exceeding the speed limit. Remember, you have the right to remain silent beyond providing your identification details.’ The advanced language model 500 could also output the relevant law, such as ‘According to California Vehicle Code Section 22350—Basic Speed Law, no person should drive a vehicle upon a highway at a speed greater than is reasonable . . . ’ In addition or alternatively, the advanced language model 500 can perform or trigger another device to perform an automated action such as ‘Display the full legal code related to speeding on the vehicle's infotainment system for the driver to read.’

In some cases, if the advanced language model 500 predicts a low risk value like ‘No Legal Infraction Identified’ for the target variable ‘Jurisdiction-Specific Legal Reference’, it might provide a different recommendation such as ‘No apparent reason for the stop based on your driving behavior. You have the right to politely ask the officer for the reason.’ It could also perform or cause a different automated action like ‘Record and store the conversation for future legal reference.’ The recommendation and/or the automated action may be based on the target variable value having a particular label (e.g., classification or categorization) and/or may be based on whether the target variable value satisfies one or more thresholds (e.g., whether the target variable value is greater than a threshold, is less than a threshold, is equal to a threshold, or falls within a range of threshold values).

In some implementations, the trained model 545 may classify (e.g., cluster) the new observation into a cluster. The observations within a cluster may share a threshold degree of similarity. For example, if the advanced language model 500 classifies the new observation in a first cluster (e.g., ‘Speeding Violations’), it may provide a first recommendation such as ‘Reduce speed to adhere to the local speed limit.’ Additionally, or alternatively, it may perform a first automated action like ‘Displaying relevant local speed limits on the dashboard’ based on the classification in the ‘Speeding Violations’ cluster.

Alternatively, if the advanced language model 500 classifies the new observation in a second cluster (e.g., ‘Failure to Signal’), it may provide a second, different recommendation like ‘Remember to use your turn signal when changing lanes or turning’ and/or may perform or trigger a different automated action like ‘Send alert to remind driver to signal before lane change.’

The recommendations, actions, and clusters described above serve as examples, with variations present in other scenarios. For example, the recommendations associated with ‘Failure to Signal’ may include ‘Always signal at least 100 feet before a turn.’ The actions associated with ‘Speeding Violations’ can include, for instance, ‘Activate audible alert for exceeding speed limit.’ The clusters associated with ‘Traffic Violation’ might include examples like ‘Distracted Driving’ or ‘Improper Lane Change.’

Through this process, the advanced language model 500 can apply a thorough and automated approach to traffic violation detection and legal advisory. It can allow for recognition and/or identification of numerous features and feature values for countless observations, thereby enhancing accuracy and consistency while reducing delay associated with manual monitoring and legal advice.

In this way, the advanced language model 500 may apply a rigorous and automated process to traffic law compliance and the provision of legal advice during traffic stops. The advanced language model 500 enables recognition and/or identification of tens, hundreds, thousands, or millions of features and/or feature values for tens, hundreds, thousands, or millions of observations, thereby increasing accuracy and consistency and reducing delay associated with delivering personalized, real-time legal advice. This is significantly more efficient compared to the traditional approach that would require allocating considerable computing resources for tens, hundreds, or thousands of operators to manually analyze driving patterns, recognize legal infractions, and provide legal advice using the features or feature values. FIG. 5B is merely illustrative. Other examples may deviate from what is described in connection with FIG. 5B.

### System for Legal Risk Mitigation and Driver Awareness

In the field of vehicle operation and law enforcement, potential infractions often arise from a driver's lack of awareness about enforcement activities in their vicinity. This issue can become more complex when considering factors such as racial profiling. To mitigate these challenges, the mitigation system disclosed herein can alert drivers about potential enforcement actions based on operating parameters and/or a geographic location. In this way, the mitigation system can prevent or reduce infractions and boost driver awareness, contributing to safer roadways.

The mitigation system can monitor various operating parameters, including the vehicle's current geographic location. The collected data can be compared with a database of enforcement actions implemented within a specific area surrounding the current location and over a set duration, and the mitigation system can notify the driver if the vehicle's operating parameters exceed predefined enforcement action criteria. Notifications can be provided through visual, auditory, or haptic feedback from the vehicle's infotainment system, dashboard display, or a connected mobile device. Furthermore, the system can generate a report detailing past enforcement actions within a user-specified time frame or geographic area. In some cases, the mitigation system can suggest alternate routes based on the frequency or severity of enforcement actions in an area. This dynamic approach can elevate driver awareness about potential legal implications of their driving behavior, resulting in a more informed driver and a safer driving experience.

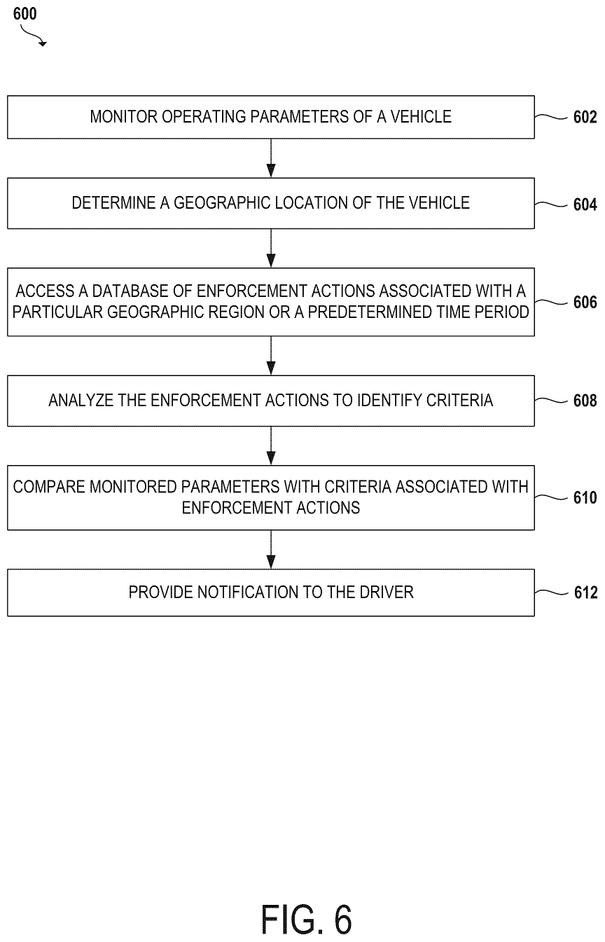

FIG. 6 is a flow diagram illustrating an embodiment of a routine 600 implemented by a mitigation system for mitigating potential racial injustice during law enforcement interactions. Although described as being implemented by the mitigation system 100 of FIG. 1, it will be understood that one or more elements outlined for routine 600 can be implemented by one or more computing devices/components associated with the mitigation system, such as the vehicle monitoring system 110, the law enforcement interaction detection system 120, the recording devices 130, the audio processing system 140, the communication system 150, or the legal information database 160. Thus, the following illustrative embodiment should not be construed as limiting.

At block 602, the mitigation system 100 can monitor and/or analyze one or more operating parameters. The operating parameters can include, but are not limited to, vehicle status parameters, vehicle performance metrics, environmental conditions, or safety feature data. Through analysis of the operating parameters, the mitigation system 100 can detect instances such as, but not limited to, exceeding a speed limit, abrupt acceleration or deceleration, or deviation from an intended lane. The monitoring or analyzing the operating parameters can allow the mitigation system 100 to offer insights into driving habits or a level of compliance with traffic regulations and can enable the mitigation system 100 to identify potential infractions and facilitate interventions for mitigation, ultimately encouraging safer driving practices.

In some cases, the mitigation system 100 can learn driver behavior patterns over time by analyzing historical data and adjusting the predefined criteria associated with enforcement actions accordingly. This can enable the mitigation system 100 to adapt to individual driving styles and tailor the notifications to each driver's preferences. For example, if a driver tends to accelerate more frequently but within acceptable limits, the mitigation system 100 can dynamically adjust the predefined criteria to reflect their specific driving behavior. This personalized approach can ensure that drivers receive relevant and timely alerts based on their unique driving patterns.

At block 604, the mitigation system 100 determines the current geographic location of the vehicle. In some cases, the mitigation system 100 utilizes advanced positioning technologies, such as GPS, GLONASS, Galileo, or BeiDou Navigation Satellite System, to ascertain the precise coordinates of the vehicle's location. By determining the vehicle's geographic position, the mitigation system 100 can gain valuable information that can be utilized for various purposes, such as retrieving jurisdiction-specific legal information, identifying local laws and regulations, and providing relevant contextual data to the driver.

At block 606, the mitigation system 100 accesses a database that contains records of enforcement actions taken within a predetermined area surrounding the current geographic location over a specific period. This database can consolidate information from various sources, including law enforcement agencies, traffic monitoring systems, and user-generated data. By tapping into this extensive repository, the mitigation system 100 can obtain a substantially comprehensive view of enforcement activities in the vicinity, enabling it to provide relevant notifications and assistance to the driver.

At block 608, the mitigation system 100 collects enforcement action records pulled from the database. The collection process can include a look at the enforcement actions happening in the predetermined area (e.g., with X miles of the geographic location, or within the same town, city, or state). The mitigation system 100 can identify the number of enforcement actions, as well as details such as the types of infractions commonly encountered (like speeding or failing to signal), the time of day when enforcement is highest, or even specific locations within the area where enforcement is most prevalent.

At block 610, the mitigation system 100 compares the monitored operating parameters of the vehicle with predefined criteria associated with enforcement actions. It evaluates the vehicle's speed, acceleration, deceleration, and lane-keeping against the predefined thresholds and criteria to determine if they exceed the specified limits. This comparison helps the mitigation system identify situations where the vehicle's operating parameters may indicate a higher likelihood of enforcement actions, thereby enabling proactive notifications and measures to enhance driver awareness and compliance.

At block 610, the mitigation system 100 executes a comparison of the monitored vehicle operating parameters against a set of predefined benchmarks associated with enforcement actions. For instance, these benchmarks might include speed thresholds dictated by posted speed limits, acceleration and deceleration rates within safety guidelines, or adherence to traffic lanes as indicated by road markers. The mitigation system 100 can evaluate parameters such as vehicle speed, rates of acceleration and deceleration, and lane observance, against these predefined benchmarks. If these operating parameters satisfy their respective thresholds, the mitigation system 100 can recognize an elevated likelihood of enforcement actions.

At block 612, the mitigation system 100 engages in the creation and dispatch of a driver-intended notification. This action can be triggered when monitored operating parameters satisfy (e.g., exceed) the predefined benchmarks associated with enforcement actions. For example, the driver-intended notification can indicate a level of enforcement activity nearby, prompting the driver to exercise caution and comply with traffic laws to avoid potential infractions. The notification can be delivered through visual, auditory, or haptic outputs via a vehicle's infotainment system, dashboard display, or a connected mobile device. The notification can serve as an alert to the driver, providing information on the quantity of enforcement actions or the likelihood of an enforcement action based on the vehicle's operating parameters and nearby enforcement activity.

System for Mitigating Potential Racial Injustice during Law Enforcement Interactions

In accordance with the inventive concept, a mitigation system is provided that monitors a vehicle's operating parameters, detects conditions indicative of a law enforcement interaction, activates recording devices, obtains jurisdiction-specific legal information, initiates communication with legal professionals and predetermined contacts, and displays this information on a user interface. The mitigation system can dynamically update the displayed legal information based on the spoken words of the law enforcement officer during the law enforcement interaction.

The mitigation system monitors various operating parameters of a user's vehicle, such as geographic location, speed, or direction, to identify conditions suggestive of an impending law enforcement interaction. Once detected, the mitigation system activates recording devices, such as integrated vehicle cameras and an audio capture device, to document the law enforcement interaction. Further, the mitigation system retrieves relevant jurisdiction-specific legal information based on the monitored geographic location, presenting it to the user for better understanding. The mitigation system can also facilitate communication with a legal aid professional and/or a predetermined group of contacts, providing real-time legal counsel and emotional support during the law enforcement interaction. All this information, including live footage, audio, legal information, and communication channels, can be displayed on a user interface, which can be accessed within the vehicle or via a mobile device. The dynamic updating of jurisdiction-specific legal information can help reduce the risk of misunderstandings or escalation during the law enforcement interaction, promoting a more informed and less stressful experience.

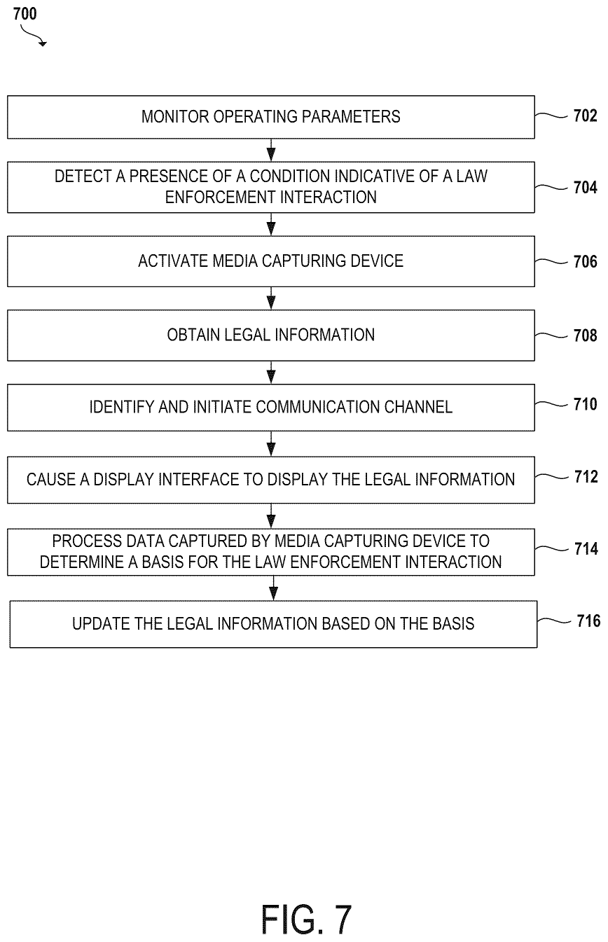

FIG. 7 is a flow diagram illustrating an embodiment of a routine 700 implemented by the mitigation system for mitigating potential racial injustice during law enforcement interactions. Although described as being implemented by the mitigation system, it will be understood that one or more elements outlined for routine 700 can be implemented by one or more computing devices/components associated with the mitigation system, such as the vehicle monitoring system 110, the law enforcement interaction detection system 120, the recording devices 130, the audio processing system 140, the communication system 150, and the legal information database 160. Thus, the following illustrative embodiment should not be construed as limiting.

At block 702, similar to block 602 of FIG. 6, the mitigation system 100 monitors and/or analyzes one or more operating parameters relating to a vehicle of a user. As described, the operating parameters can include, but are not limited to, the geographic location of the vehicle. The geographic location can include the exact location, proximate locations (e.g., state, city, county). As described herein, the geographic position can denote a substantially precise location of the vehicle or could be linked to more expansive regions such as a city, county, or state. As described, the ascertainment of the geographic location can improve the effectiveness of the mitigation system 100, as it can guide the application or determination of relevant legal data specific to the identified location.

At block 704, the mitigation system 100 detects techniques to detect conditions that indicate an impending law enforcement interaction. For instance, the mitigation system 100 can analyze indicators such as the proximity of an emergency vehicle, the activation of emergency lights, or audible signals like sirens. By leveraging data from sensors and algorithms, the mitigation system 100 can assess the likelihood of a law enforcement encounter based on these indicators. As an example, if the mitigation system 100 detects an emergency vehicle within a certain distance from the user's vehicle, it may infer the potential for a law enforcement interaction. Additionally, when emergency lights are activated on a nearby vehicle, it can serve as an indication that a law enforcement encounter may be imminent. In some cases, the mitigation system 100 can analyze distinct audible signals, such as sirens, to anticipate the possibility of a law enforcement interaction. By effectively monitoring and interpreting these indicators, the mitigation system 100 enhances driver awareness and preparedness during law enforcement encounters.

At block 706, upon detecting the condition indicative of an impending law enforcement interaction, the mitigation system 100 activates recording devices. These recording devices include a set of integrated vehicle cameras strategically positioned to capture image data from select interior and exterior zones of the vehicle during the law enforcement interaction. Additionally, an audio capture device captures the audio during the law enforcement interaction. For example, the integrated cameras can record the actions of both the driver and the law enforcement officer, while the audio capture device records their conversation. The captured data provides an objective record of the law enforcement interaction, which can be used for review, evidence in disputes, or legal proceedings.

At block 708, based on the geographic location of the vehicle, the mitigation system obtains jurisdiction-specific legal information. This information includes local laws, regulations, penalties associated with different violations, and procedural details specific to the jurisdiction in which the vehicle is located. For example, if the vehicle is pulled over in a particular jurisdiction, the mitigation system retrieves and presents legal information that pertains to traffic stops within that jurisdiction. This ensures that the driver has access to relevant and accurate legal knowledge, enhancing their understanding and response during a law enforcement interaction.

At block 710, the mitigation system 100 identifies and initiates communication with a legal aid professional based on the geographic location of the vehicle. This legal aid professional can be an attorney, paralegal, or a legal advisor with expertise in local law. Their role is to provide real-time legal counsel and assistance to the driver during the law enforcement interaction. For instance, the legal aid professional can offer guidance on the driver's rights, appropriate responses, or potential courses of action based on the specific jurisdiction and the nature of the law enforcement interaction.

In some cases, the mitigation system 100 initiates communication with a predetermined group of contacts associated with the vehicle or the user. This predetermined group of contacts may include family members, friends, or legal representatives. The mitigation system establishes open lines of communication through various means such as text messages, voice calls, or live video communication. This ensures that the driver is not isolated during a potential law enforcement interaction and maintains a connection to a trusted network for support and assistance.

At block 712, the mitigation system 100 causes a display interface within the vehicle or on a mobile communication device to present jurisdiction-specific legal information and a communication channel with the legal aid professional or the contacts. As described, the display interface can serve as a hub, providing information and communication options to the driver during the law enforcement interaction. The interface can offer visual or auditory cues to guide the driver based on the relevant local law information and the officer's spoken words. It may also suggest appropriate responses or actions based on the presented legal information, the driver's rights, and the officer's explanation of the reason for the law enforcement interaction.

At block 714, the mitigation system 100 utilizes an advanced language model, as described herein, to process the data captured by the media capturing devices and determine the basis or reason for the law enforcement interaction. The mitigation system 100 can leverage the capabilities of the advanced language model to analyze the officer's spoken words, which can include an explanation for the interaction. By employing this language model, the mitigation system 100 can determine the basis and obtain updated jurisdiction-specific legal information related to the basis. For example, if the officer mentions a specific traffic violation, the mitigation system 100 can retrieve pertinent legal information related to that violation within the current jurisdiction.

At block 716, the mitigation system 100 dynamically and recursively updates the presented legal information based on the information obtained at block 714.

### Terminology

Computer programs typically comprise one or more instructions set at various times in various memory devices of a computing device, which, when read and executed by at least one processor, will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is otherwise understood with the context as used in general to convey that an item, term, etc. may be either X, Y or Z, or any combination thereof. Thus, such conjunctive language is not generally intended to imply that certain embodiments require at least one of X, at least one of Y and at least one of Z to each be present. Further, use of the phrase “at least one of X, Y or Z” as used in general is to convey that an item, term, etc. may be either X, Y or Z, or any combination thereof.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources. In certain embodiments, one or more of the components described herein can be implemented in a remote distributed computing system. In this context, a remote distributed computing system or cloud-based service can refer to a service hosted by one more computing resources that are accessible to end users over a network, for example, by using a web browser or other application on a client device to interface with the remote computing resources.

When implemented as a cloud-based service, various components described herein can be implemented using containerization or operating-system-level virtualization, or other virtualization technique. For example, one or more components can be implemented as separate software containers or container instances. Each container instance can have certain resources (e.g., memory, processor, etc.) of the underlying host computing system assigned to it, but may share the same operating system and may use the operating system's system call interface. Each container may provide an isolated execution environment on the host system, such as by providing a memory space of the host system that is logically isolated from memory space of other containers. Further, each container may run the same or different computer applications concurrently or separately, and may interact with each other. Although reference is made herein to containerization and container instances, it will be understood that other virtualization techniques can be used. For example, the components can be implemented using virtual machines using full virtualization or paravirtualization, etc. Thus, where reference is made to “containerized” components, it should be understood that such components may additionally or alternatively be implemented in other isolated execution environments, such as a virtual machine environment.

Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the mitigation systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the mitigation system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application, in either this application or in a continuing application.

What is claimed is:

1. A method for mitigating potential racial injustice during law enforcement interactions, the method comprising:
monitoring operating parameters of vehicle of a user, the operating parameters comprising geographic data for the vehicle;
detecting a presence of a condition indicative of a law enforcement interaction;
activating a set of media capturing devices, the set of media capturing devices comprising an audio capturing device for obtaining audio data relating to the law enforcement interaction and an image capturing device for obtaining image data relating to the law enforcement interaction;
obtaining first legal information for the law enforcement interaction based on the geographic data;
identifying and initiating communication with a legal aid professional based on the geographic data;
causing a display within the vehicle to display the first legal information, a communication channel with the legal aid professional;
processing the audio data captured by the audio capturing device during the law enforcement interaction to determine a basis for the law enforcement interaction;
obtaining second legal information for the law enforcement interaction based on the basis for the law enforcement interaction; and
causing the display to display the second legal information.

2. The method of claim 1, wherein the processing comprises inputting the audio data into a trained neural network model that interprets spoken language in the audio data and determines the basis of the law enforcement interaction.

3. The method of claim 1, wherein the media comprises video data captured by the audio capturing device during the law enforcement interaction, and wherein the processing comprises inputting the video data into a trained neural network model that analyzes and interprets movements and behavior of an officer to determine the basis of the law enforcement interaction.

4. The method of claim 1, wherein the processing is executed in a continuous and iterative manner throughout the duration of the law enforcement interaction.

5. The method of claim 1, wherein the condition indicative of the law enforcement interaction includes a presence of active emergency lights on an emergency vehicle in proximity to the vehicle.

6. The method of claim 1, further comprising:
initiating communication with a predetermined group of contacts; and
causing a display within the vehicle to display a communication channel with the predetermined group of contacts.

7. The method of claim 1, wherein the operating parameters comprise vehicle status parameters comprising at least one of speed, direction, geospatial location, exterior lighting status, turn signal usage, windshield wiper operation, seatbelt usage, door lock status, or vehicle weight.

8. The method of claim 1, wherein the operating parameters comprise vehicle performance metrics comprising at least one of revolutions per minute (RPM), engine temperature, fuel efficiency, tire pressure, or brake status.

9. The method of claim 1, wherein the operating parameters comprise environmental conditions comprising at least one of ambient light conditions, road conditions, weather data, or traffic patterns.

10. The method of claim 1, wherein the operating parameters comprise safety feature data comprising at least one of lane-keeping data, adaptive cruise control status, alerts from collision avoidance systems, or airbag deployment status.

11. The method of claim 1, wherein said activating a set of media capturing devices is based on a determination that the vehicle being is in a parked state.

12. The method of claim 1, further comprising transmitting the audio data and the video data to a remote storage location for secure and tamper-resistant storage.

13. The method of claim 1, wherein the legal aid professional comprises an attorney, paralegal, or a legal advisor with expertise in local law.

14. The method of claim 1, further comprising providing the user with suggested responses or actions.

15. The method of claim 1, wherein the predefined criteria associated with enforcement actions are user-configurable, allowing the driver to customize the threshold for receiving notifications.

16. The method of claim 1, further comprising generating a historical enforcement action report for the driver, including information on enforcement actions taken within a user-selected time frame or geographic area.

17. The method of claim 1, wherein the vehicle's operating parameters are monitored using a combination of sensors integrated within the vehicle, external sources, or data provided by a connected mobile device.

18. The method of claim 1, further comprising learning driver behavior patterns over time and adjusting the predefined criteria associated with enforcement actions or the risk level calculation based on the learned behavior patterns.
